(19) United States
(12) Patent Application Publication
(10) Pub. No.: US 2005/0240475 A1
(43) Pub. Date: Oct. 27, 2005

(54) Systems and methods for universal online advertising

(76) Inventors: William A. Margiloff, New York, NY (US); Anthony M. Risicato, New York, NY (US); Christopher J. Hansen, Brooklyn, NY (US)

Correspondence Address: BUCKLEY, MASCHOFF, TALWALKAR LLC, 5 ELM STREET, NEW CANAAN, CT, 06840, US

(21) Appl. No.: 11/111,172

(22) Filed: Apr. 21, 2005

Related U.S. Application Data
(60) Provisional application No. 60/564,781, filed on Apr. 23, 2004.

(51) Int. Cl. G06F 17/60

(52) U.S. Cl. 705/14; 705/10; 705/1

(57) ABSTRACT

According to some embodiments, systems, methods, and articles of manufacture are provided for universal advertisement management. More specifically, in some embodiments advertisements displayed via various advertising partners may be automatically managed. According to some embodiments, real-time information associated with the universal advertising management may be provided.

### CROSS-REFERENCE TO RELATED APPLICATIONS

This application claims priority and benefit under 35 U.S.C. § 119(e) to U.S. Provisional Patent Application Ser. No. 60/564,781, entitled “Systems and Methods for Universal Online Advertising”, filed in the name of Margiloff et al. on Apr. 23, 2004, the contents of which are hereby incorporated by reference in their entirety for all purposes.

### FIELD

The present invention relates to online advertising. In particular, the present invention relates to systems and methods for universal online advertising, such as (i) establishing universal advertising accounts, (ii) managing universal advertising accounts, and (iii) providing real-time universal advertising account information.

### BACKGROUND

Businesses, corporations, organizations, and individuals often advertise products, services, or information by placing advertisements online. The manufacturer, wholesaler, or retailer of a product may, for example, directly contact the provider of a website to establish an advertising relationship. Some organizations or website providers may permit an advertiser to sign-up to display advertisements on multiple participating websites. In either case, the advertiser typically must then pursue information regarding the performance of displayed advertisements, so that the advertiser may effectively manage an advertising campaign.

Managing advertising performance may require an advertiser to decide how much it is willing to pay to have an advertisement displayed. Many websites, for example, have limited advertising space available and therefore allow advertisers to bid for advertisement display space. Advertisers may be ranked based on their current bid, and the advertisement from the highest ranking/highest bidding advertiser may be displayed in the available space. Advertisers may visit the website to view the rankings so that they may, for example, adjust their bids to “win” the advertising space.

### BRIEF DESCRIPTION OF THE DRAWINGS

FIG. 1 is a block diagram overview of a system according to some embodiments.

FIG. 2 is a block diagram of a system according to some embodiments.

FIG. 3 is an exemplary database table according to some embodiments.

FIG. 4 is a flow chart of a method according to some embodiments.

FIG. 5 illustrates a display according to some embodiments.

FIG. 6 is a flow chart of a method according to some embodiments.

### DETAILED DESCRIPTION

Some embodiments described herein are associated with an “advertising parameter.” As used herein, the term “advertising parameter” generally refers to any value, metric, calculation, and/or other information relating to and/or associated with an advertisement. Examples of advertising parameters may include, but are not limited to, Cost Per Acquisition (CPA), Cost Per Click (CPC), Cost Per thousand (“M”) (CPM), impressions, click-throughs, an advertisement identifier, an advertisement position, and an advertisement size.

As used herein, the term “advertisement” may generally refer to any textual, audio, video, digital, and/or other form, type, or configuration of information. Advertisements may be presented to consumers or other users, for example, to provide information, promote and/or sell products or services, and/or otherwise to convey information to, collect information from, and/or communicate with another party, entity, and/or group or organization. In some embodiments, advertisements may include text, graphics, and/or interactive objects such as text boxes, check boxes, and/or command buttons.

System Overview

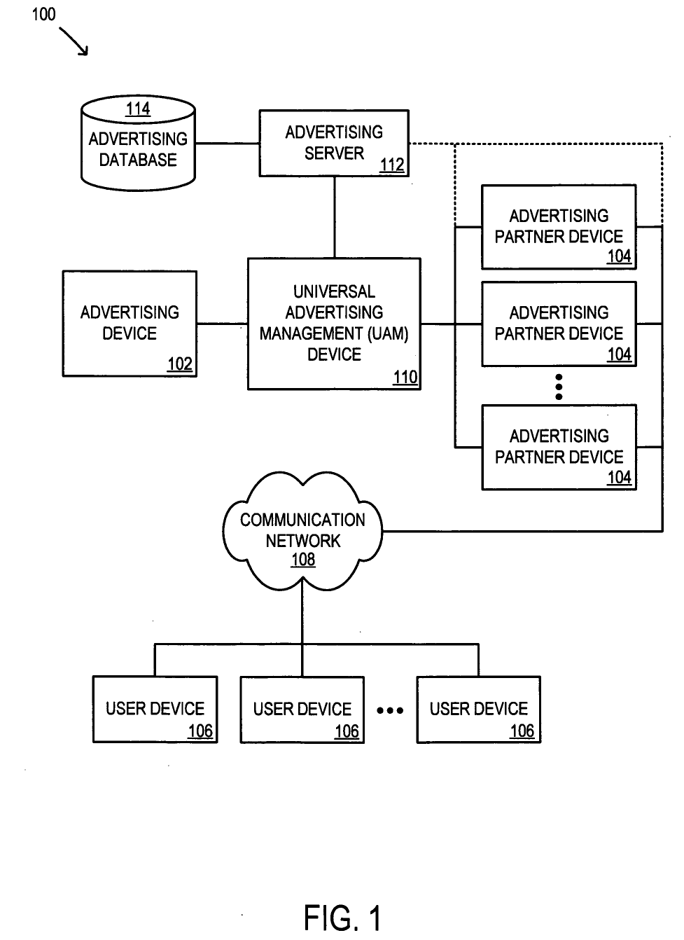

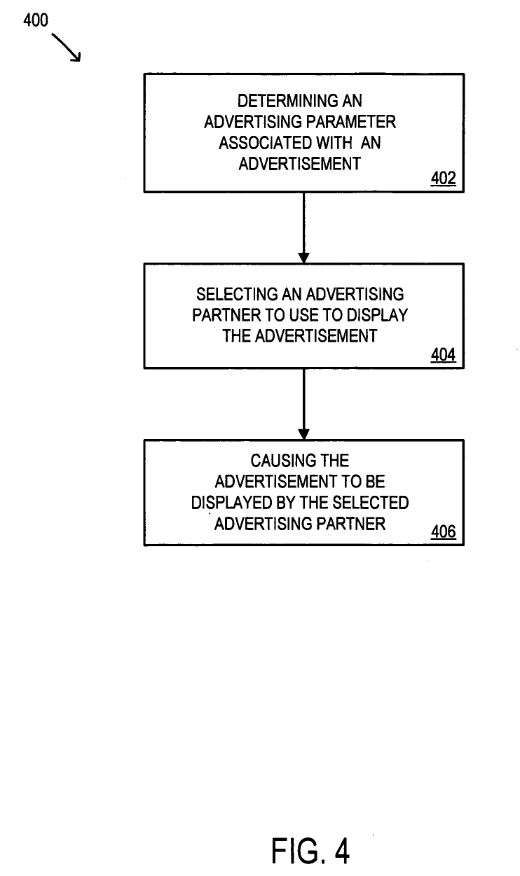

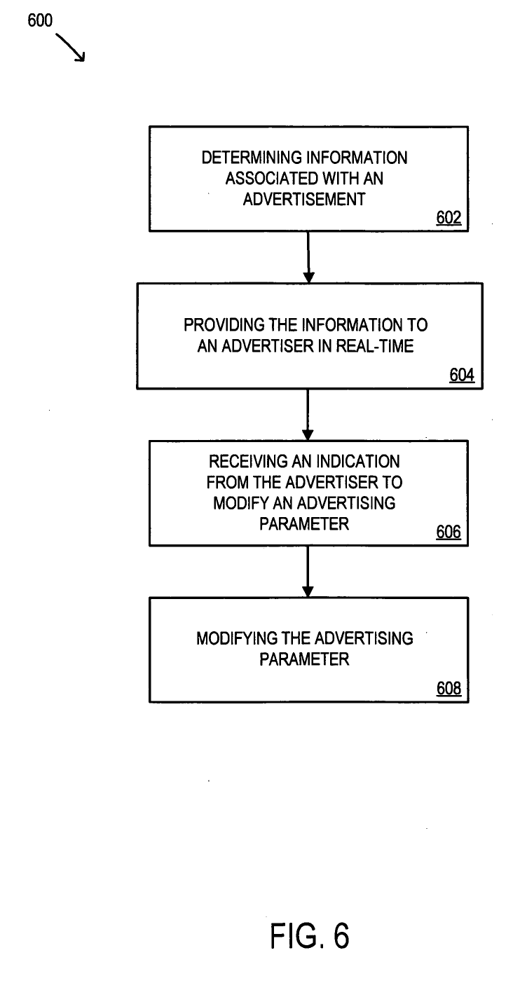

Turning now in detail to the drawings, in FIG. 1 a block diagram of a system 100 is depicted for use in explanation, but not limitation, of described embodiments. Different types, layouts, quantities, and configurations of systems may be used. The system 100 may be associated with, for example, the methods 400 and/or 600 described in conjunction with FIG. 4 and FIG. 6, respectively herein.

In some embodiments, the system 100 may include an advertising device 102, an advertising partner device 104, and a user device 106. The advertising device 102 may be, for example, a device used or operated by and/or on behalf of an advertiser. In some embodiments, the advertiser may wish to display one or more advertisements on a website for viewing by a user operating a user device 106. The website may be operated, owned, affiliated with, and/or operated by, for example, an advertising partner using an advertising partner device 104. According to some embodiments, the advertising partner device 104 may provide the advertisement to the user device 106 via a communication network 108. The advertisement may be provided in connection with a website which the user device 106 may access, for example, via a communication network 108 such as the Internet.

The system 100 may, according to some embodiments, include a Universal Advertising Management (UAM) device 110. The UAM device 110 may be, for example, a device that implements and/or is otherwise associated with the methods 400 and/or 600 described in conjunction with FIG. 4 and FIG. 6, respectively herein. In some embodiments, the UAM device 110 may be a device operated by an advertising management company, group, individual, and/or other entity. The UAM device 110 may, according to some embodiments, allow an advertiser (e.g., using an advertising device 102) to register for universal advertising management services. For example, the advertiser may use the advertising device 102 to register with the UAM device 110 and/or subscribe to services provided by the UAM device 110.

In some embodiments, the advertiser's registration with the UAM device 110 may permit the advertiser to display advertisements via various advertising partner devices 104 (e.g., the UAM device 110 may provide “universal” advertising services). As used herein, the term “universal” may generally refer to the aggregation, facilitation, and/or other association of advertising data, services, and/or products with and/or on or through a variety of potential advertising partners. For example, the advertiser's single registration with the UAM device 110 may permit, facilitate, and/or otherwise conduct automatic registration of the advertiser with any or all of the various advertising partner devices 104. For example, the UAM device 110 may operate and/or have access to a batch program, bot, an Application Program Interface (API), artificial intelligence (AI), and/or other automatic program, system, or device that uses the advertiser's registration information to automatically register with various advertising partners. The UAM device 110 might arrange for the advertiser to be registered with an advertising partner device 104, for example, using a standard interface (e.g., via a Web site that advertisers typically use to register with an advertising partner) or a dedicated and/or direct-feed between the UAM device 110 and an advertising partner device 104.

In some embodiments, the advertiser may select which advertising partners are preferable and/or acceptable to display a particular advertisement and/or group of advertisements. The advertiser may then, for example, be automatically signed-up and/or registered with the selected advertising partners by the UAM device 110.

In some embodiments, the UAM device 110 may have access to, be, include, control, and/or otherwise be in communication with an advertising server 112. The advertising server 112 may, for example, be a server or other computer for managing advertisements. In some embodiments, a webpage displayed on a user device 106 may contain a link and/or other reference pointing to a location within the advertising server 112. The advertising server 112 may, for example, also be or include a web server and/or other web interface. In some embodiments, the advertising server 112 may be, include, and/or be in communication with an advertising database 114. For example, the UAM device 110 may direct the advertising server 112 to send an advertisement to an advertising partner device 104 and/or a user device 106. The advertising server 112 may, according to some embodiments, retrieve information indicative of and/or associated with the requested advertisement from the advertisement database 114. The information may then be transmitted and/or provide to, for example, either or both of the advertising partner device 104 and/or the user device 106.

As used herein, devices (such as the advertising partner devices 104 and the user device 106) may communicate via the communication network 108, such as a Local Area Network (LAN), a Metropolitan Area Network (MAN), a Wide Area Network (WAN), a proprietary network, a Public Switched Telephone Network (PSTN), a Wireless Application Protocol (WAP) network, a cable television network, or an Internet Protocol (IP) network such as the Internet, an intranet or an extranet. Note that the devices shown in FIG. 1 need not be in constant communication. For example, the user device 106 may only communicate with an advertising partner device 104 via the Internet on an as-needed basis. In some embodiments, for example, the user device 106 may be a Personal Computer (PC) that intermittently utilizes a dial-up connection to the Internet via an Internet Service Provider (ISP). In other embodiments the user device 106 may be in constant and/or high-speed communication with one or more advertising partner devices 104 (and/or with the UAM device 110 or advertising server 112) through the use of any known or available connection device such as a cable or Digital Subscriber Line (DSL) modem. According to some embodiments, the communication network 108 may be or include multiple networks of varying type, configuration, size, and/or functionality. In some embodiments, any and/or all components of the system 100 may communicate via the communication network 108.

As shown in FIG. 1, multiple advertising partner devices 104 and/or user devices 106 may be included in system 100. Any number of the other devices described herein may also be included in the system 100 according to some embodiments. A single UAM device 110 may, for example, be in communication with multiple advertising devices 102 and/or multiple advertising servers 112. In some embodiments, the advertising server 112 may be or include multiple content servers (such as operated and/or provided by one or more advertising partner devices 104) may provide various information such as advertisements and/or web pages to one or more user devices 106.

The various devices 102, 104, 106, 110, 112 described herein may be any devices that are or become known or available and are capable of performing the various functions described herein. Each and/or every one of the devices 102, 104, 106, 110, 112 may be, for example: a PC, a portable computing device such as a Personal Digital Assistant (PDA), an interactive television device, or any other appropriate storage and/or communication device. Either or both of the advertising server 112 and the advertising partner device 104 may be, for example, advertising and/or content servers such as web servers.

Universal Advertisement Management

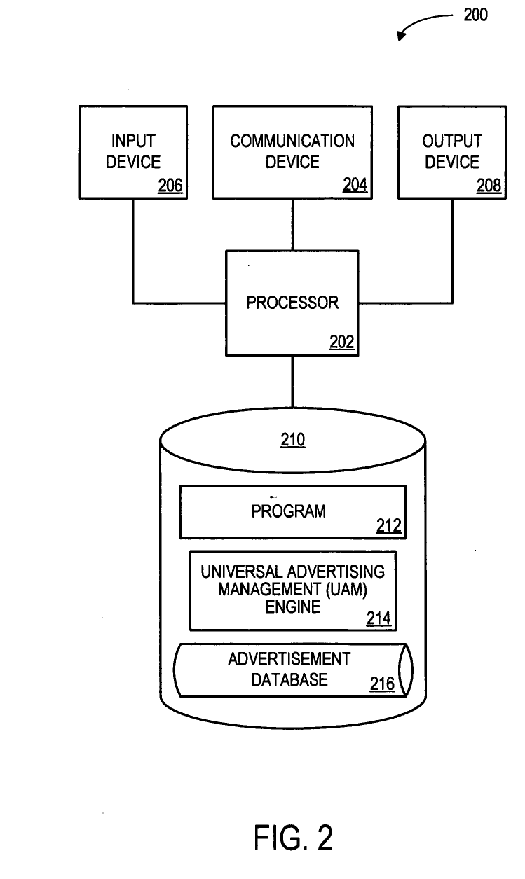

Referring now to FIG. 2, a block diagram of a system 200 in accordance with some embodiments is shown. The system 200 may, for example, be or be similar to and/or include the UAM device 110 described in conjunction with FIG. 1 above. The system 100 may, according to some embodiments, be associated with and/or perform the methods 400 and/or 600 described in conjunction with FIG. 4 and FIG. 6, respectively herein. In some embodiments, fewer or more components than are shown in FIG. 2 may be included in the system 200.

In some embodiments, the system 200 may include a processor 202, such as one or more Intel® Pentium® processors, coupled to a communication device 204 configured to communicate via a communication network (such as communication network 108 in FIG. 1). The communication device 204 may be used to communicate, for example, with one or more advertising devices 102, advertising partner devices 104, and/or advertising servers 112 as described in conjunction with the system 100 herein. The system 200 may further include an input device 206 (e.g., a mouse and/or keyboard) and an output device 208 (e.g., a computer and/or a television monitor).

As used herein, information may be “received” by or “transmitted” to, for example: (i) the system 200 from another system and/or device, and/or (ii) a software application or module within the system 200 from another system, software application, module, and/or any other source. For example, advertising information processed by the processor 202 may be sent via the communication device 204 to an advertising device 102 and/or an advertising partner device 104.

In some embodiments, the processor 202 may also communicate with a storage device 210. The storage device 210 may comprise any appropriate information storage device that is or becomes known or available, including, but not limited to, combinations of magnetic storage devices (e.g., a hard disk drive), optical storage devices, and/or semiconductor memory devices such as Random Access Memory (RAM) devices and Read Only Memory (ROM) devices.

The storage device 210 may, for example, store a program 212 for controlling the processor 202. The processor 202 may perform instructions of the program 212, and for example, thereby operate in accordance with embodiments described herein. The program 212 may be stored in a compressed, un-compiled and/or encrypted format. The program 212 may furthermore include other program elements, such as an operating system, a database management system, and/or device drivers used by the processor 202 to interface with peripheral devices. In some embodiments (such as shown in FIG. 2), the storage device 210 may also or alternatively store a UAM engine 214.

The UAM engine 214 may, for example, be or be similar in configuration and/or functionality to the UAM device 110 described in conjunction with system 100 herein. In some embodiments, the UAM engine 214 may operate in accordance with the methods 400 and/or 600 described in conjunction with FIG. 4 and FIG. 6, respectively. For example, the UAM engine 214 may manage one or more advertisements and/or advertising campaigns for an advertiser. The UAM engine 214 may, according to some embodiments, manage an advertiser's bids associated with various advertising partners. For example, the UAM engine 214 may monitor the performance of an advertisement and dynamically adjust bidding and/or other advertising parameters in an attempt to meet an advertiser's goals. According to some embodiments, the UAM device 110 may, for example, automatically adjust an advertising parameter to an allowable level or value within a bidding engine of an advertising partner device 104. In some embodiments, advertising parameters associated with various advertising partners may be converted by the UAM engine 214 to one or more uniform metrics for appropriate comparison. The UAM engine 214 may also or alternatively select one or more advertising partners to display an advertisement with, based in part for example, on parameters, ranges, and/or other values, metrics, or criteria established by the advertiser. In some embodiments, the advertising management service provided by the UAM device 110 may be automatic and/or conducted in real-time.

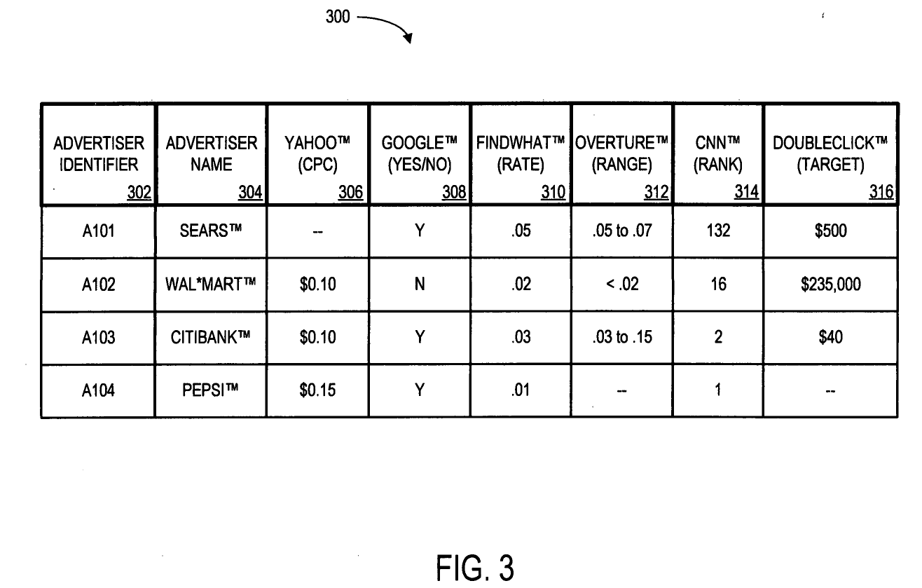

In some embodiments, the UAM engine 214 may utilize advertising parameter information stored in an advertisement database 216 within the storage device 210. In some embodiments, the advertisement database 216 may be or be similar to the advertising database 114 described in conjunction with system 100. The advertisement database 216 may be used, for example, to store contextual advertisements and/or other promotional and/or contextual material or information. In some embodiments, the information stored in the advertisement database 216 may be used, for example, to provide and/or display advertisements in accordance with embodiments described herein. The advertisement database 216 may, according to some embodiments, also or alternatively store advertisement performance information which may be used, for example, to provide performance and/or progress reports to an advertiser. One example of an advertisement database 216 that may be used in connection with the system 200 will now be described in detail with respect to FIG. 3.

Referring to FIG. 3, a table 300 is shown that may represent the advertisement database 216 (and/or a portion thereof) and/or that may be stored in the system 200 (e.g., by the storage device 210) according to some embodiments. The information in the table 300 may be created and updated, for example, based on information received from an advertisement server 112 (e.g., on a nightly basis) and/or other device or entity. The table 300 may include, for example, fields for an advertiser identifier 302 and an advertiser name 304. The advertiser identifier 302 may be, for example, an alphanumeric code associated with an advertiser that may have registered with the UAM device 110 in system 100 (and/or with system 200). The advertiser name 304 may be or include the formal and/or other descriptive name of the associated advertiser. For example, the advertiser identified as “A101” may be the Sears, Roebuck and Co.®, represented simply as “Sears™”. The table may also define, for example, advertising partners for each of the registered and/or subscribed advertisers represented in field 304. The advertising partner fields 306, 308, 310, 312, 314 may, according to some embodiments, include various information represented in any form that is practicable and/or is or becomes known or available.

For example, the field 306 shown as being associated with the advertising partner “Yahoo™”, may contain information such as cost per click information. The information in field 306 may represent, for example, the cost per click that each individual advertiser is willing to pay for advertisements to be displayed on or by Yahoo™. In some embodiments, such as where an advertiser may not want to advertise with a particular partner, no cost per click information may be stored and/or displayed. For advertiser “Sears™”, for example, no cost per click information is stored in field 306.

For the advertising partner “Google™”, the advertising information shown in field 308 may represent the willingness of each advertiser to participate with the given partner. The displayed information, for example, may include a “Y” or “N” (as shown) representing (e.g., with either a “yes” or “no” indication) whether an advertiser is or is not willing and/or interested in advertising with Google™. Other affirmative and/or negative indications may be stored in any form that is practicable. In some embodiments for example, the field 308 may contain either a one (representing “yes”) or a zero (representing “no”).

Other information associated with other advertising partners may be similarly stored and/or displayed in various fields 310, 312, 314, 316. For example, information associated with the partner “FindWhat™” may be stored in field 310 and may include statistical and/or rate information such as a click-through rate (as shown). In some embodiments, such as for the information associated with partner “Overture™”, an advertiser may specify a range of values which are acceptable for a given parameter. For example, if the range information stored in field 312 is associated with cost per click, the advertiser “Citibank™” may be willing to pay between three and fifteen cents per click for advertisements to be displayed by “Overture™”. In some embodiments, systems and/or devices such as the UAM device 110 may utilize this range information to bid on behalf of an advertiser for advertising space available through various advertising partners. In some embodiments, the bidding may be conducted, for example, to increase the rank of an advertiser while attempting to reduce the cost per click (within the specified range) needed to do so. The rank information associated with an advertiser may also or alternatively be stored and/or displayed. For example, based on the information shown in field 314, “Pepsi™” is the number-one ranked advertiser for the partner “CNN™”. Other information such as advertiser target campaign expenditures (or revenues) may also be displayed, such as in field 316. For example, the allowable expenditures an advertiser is willing to make with respect a particular advertising partner and/or advertisement may be stored in field 316.

In some embodiments, the table 300 may contain any other information that is practicable for carrying out the embodiments described herein. For example, the table 300 may comprise a pointer indicating from where advertisement information (e.g., text, graphic, audio, and/or executable information) can be retrieved or may be or include the information itself. Other information such as one or more advertisement rules that indicate when an advertisement should be provided to a user (e.g., based on a keyword or URL), may also be stored. In some embodiments, the information stored in table 300 may take any form that is or becomes known or available and/or is described herein (e.g., in conjunction with fields 306, 308, 310, 312, 314, 316). According to some embodiments, the advertising partner may be or include a partner operating a single website or group of websites (e.g., “CNN™”), or may be or include a partner that accepts advertisements for display on various participating third-party websites (e.g., “DoubleClick™”, “Overture™”, etc.). Although the fields 306,308, 310, 312, 314, 316 are shown in FIG. 3 as being associated with the particular entities shown (e.g., Yahoo™), it should be understood that any combination of entities, values, variables, and/or metrics may be stored in the fields 306, 308, 310, 312, 314, 316 without deviating from some embodiments.

Referring now to FIG. 4, a flow chart of a method 400 according to some embodiments is shown. The method 400 may be associated with and/or performed by, for example, the systems 100 or 200 (or one or more of the system components) described in conjunction with any of FIG. 1 and/or FIG. 2 above. The flow diagrams described herein do not necessarily imply a fixed order to the actions, and embodiments may be performed in any order that is practicable. Note that any of the methods described herein may be performed by hardware, software (including microcode), firmware, or any combination thereof. For example, a storage medium may store thereon instructions that when executed by a machine result in performance according to any of the embodiments described herein.

The method 400 may begin, for example, by determining an advertising parameter associated with an advertisement, at 402. For example, an advertiser may specify (using an advertiser device 102, for example) a maximum Cost Per thousand (“M”) (CPM) that the advertiser is willing to pay to have an advertisement displayed. The advertiser may specify any parameter relating to and/or otherwise associated with a particular advertisement. For example, and advertiser may specify that for a certain group of new car advertisements, the advertiser is only willing to pay up to ten cents per thousand impressions. In some embodiments, the advertiser may specify other criteria, limitations, and/or metrics. For example, the advertiser may also or alternatively specify that, for the same advertisements, the advertiser would prefer to pay less than seven cents per thousand impressions. According to some embodiments, the parameter may be retrieved from memory or storage and/or otherwise determined. For example, the appropriate size for an advertisement may be stored in a field within an advertising database (such as database 114, 216, and/or table 300).

In some embodiments, the method 400 may continue at 404 by selecting an advertising partner to use to display an advertisement. The partner may be selected, for example, based upon the advertising parameter determined at 402. In some embodiments, a plurality of potential advertising partners may be considered. The current bidding levels and advertiser ranks associated with each partner may be analyzed, for example. In some embodiments, a partner may be chosen based upon whether a parameter specified by an advertiser may be satisfied by utilizing the partner to display an advertisement. For example, partners may be associated with known click-through rates (or other parameters). Where an advertiser has specified that the click-through rate for an advertisement should be no less than five percent, a partner that has historically had advertisements displayed with click-through rates in excess of five percent may be selected. In some embodiments, such as where available metrics for various partners may vary in type, one or more of the metrics may be converted to another type so that partners may be appropriately compared.

In some embodiments, the advertisement may be caused to be displayed by the selected advertising partner, at 406. For example, the advertisement may be retrieved from an advertising server (such as server 112) and sent to the selected partner for display (e.g., sent to an advertising partner device 104). In some embodiments, the advertisement may be selected for display and the advertising partner may be directed to display the advertisement as is appropriate. For example, various advertisements may be stored directly and/or locally by the advertising partner. The partner may then be transmitted information regarding which of the stored advertisements should be used and/or displayed. In some embodiments, the advertising partner (and/or a user) may be provided with a link or other information pointing to the location of and/or otherwise regarding which advertisement should be displayed. In some embodiments, payment to the advertising partner may be effectuated to cause the partner to display the advertisement.

According to some embodiments, data relating to an advertisement's performance may be stored and/or analyzed. For example, various advertising parameters such as click-through rate or conversion rate may be monitored for advertisements displayed through various advertising partners. This information may be used, for example, in selecting an appropriate partner at 404. In some embodiments, the information may be analyzed, summarized, aggregated, and/or otherwise managed. The processed information may then, for example, be provided to an associated advertiser to allow the advertiser to monitor, track, and/or review advertising performance. In some embodiments, raw data regarding performance may be provided to an advertiser so that the advertiser may perform custom, private, and/or proprietary analysis. According to some embodiments, data regarding advertisement performance may be used to repeat the method 400 to manage advertisements automatically and/or in real-time. For example, advertising parameters associated with various advertisements and/or advertising partners may be updated continuously (and/or often), and adjustments may be made in certain parameters and or selected partners or advertisements in an attempt to increase advertising revenues or other metrics.

Advertising Ticker

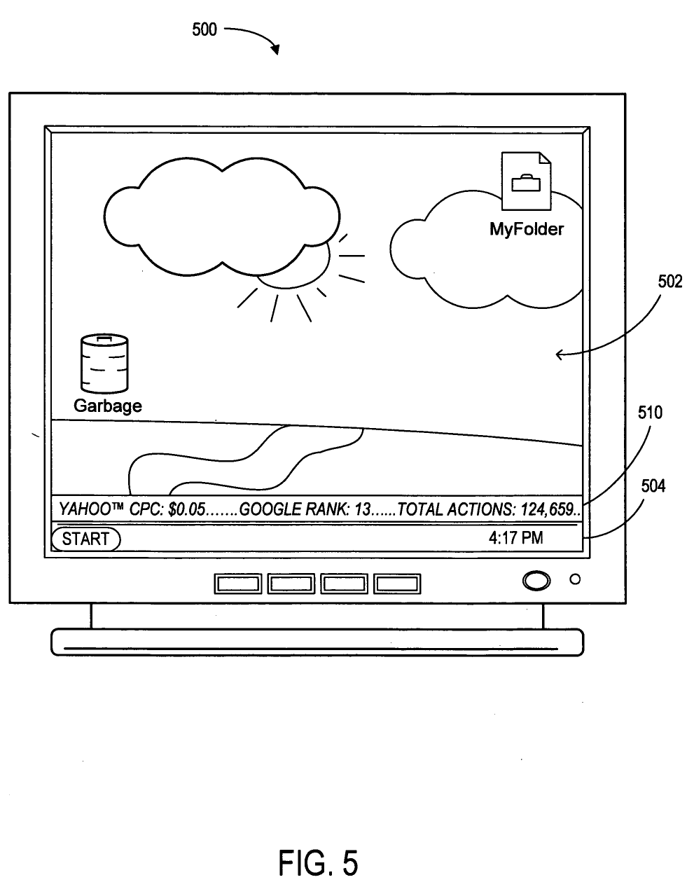

Turning now to FIG. 5, an example of a display 500 according to some embodiments is shown. The display 500 may, for example, be associated with the method 400 described above and/or with the method 600 described below. In some embodiments, the display 500 may be associated with an operating system and may include a desktop 502 and/or a task bar 504. The operating system may be any operating system that is or becomes known or available, such as any of the Windows™ Operating Systems provided by the Microsoft® Corporation. In some embodiments for example, the operating system may be or include the program 212 described in conjunction with system 200. The display 500 may, according to some embodiments, also or alternatively include an advertising ticker 510.

The advertising ticker 510 may, for example, be or include an area within the display 500 (and/or on or within the desktop 502) that shows, presents, and/or provides advertising information. In some embodiments, the advertising ticker 510 may include information such as advertising parameters associated with an advertiser, an advertisement, and/or an advertising partner. For example, the advertising ticker 510 may be provided on the display 500 associated with an advertiser (and/or on an advertising device 102). The advertising ticker 510 may show, for example, information associated with advertisements the advertiser is currently displaying via various partners.

As shown in FIG. 5, the information displayed may include, for example, the current cost per click that the advertiser has bid for space available through a particular partner (“Yahoo™ CPC: $0.05”). The advertising ticker 510 may also or alternatively display the current rank of the advertiser, such as the thirteenth rank shown for the advertiser in relation to the partner “Google™”. Summary information such as the total number of consumer actions resulting from the current advertisement and/or campaign may also or alternatively be displayed.

In some embodiments, the advertising ticker 510 may include an information display area, various graphics or icons, and/or one or more menus of various types and/or configurations. According to some embodiments for example, the advertising ticker 510 may include buttons, forms, menus, text boxes, and/or other interactive items or objects that a user (such as an advertiser) may use to communicate with, for example, a UAM system and/or device. In some embodiments, the advertising ticker 510 may automatically scroll and/or refresh information to provide a user (such as an advertiser) with real-time advertising parameter information. According to some embodiments, the user may then utilize interactive features provided by the advertising ticker 510 to provide feedback to the UAM device and/or entity and/or to dynamically change, modify, and/or otherwise edit or review one or more particular advertising parameters.

In some embodiments, the advertising ticker 510 may be provided to an advertiser (or other user) as a downloadable program and/or module. The ticker 510 may, for example, be or include a program, plug-in, and/or other software that is developed and/or compatible with Hyper-Text Markup Language (HTML), JAVA™, C++, and/or any other programming language.

FIG. 6 shows a method 600 for providing real-time advertising information to a user in accordance with some embodiments. The method 600 may be associated with and/or carried out or implemented, for example, by systems 100 or 200 or by the advertising ticker 510 described herein. The method 600 may begin, according to some embodiments, by determining information associated with an advertisement at 602. The information may be any information that is or becomes know or available and relates, regards, and/or is otherwise associated with an advertisement. The information may be or include, for example, an advertising parameter.

At 604, the information may be provided to an advertiser. For example, using the advertising ticker 510 and/or any other display mechanism, an advertising parameter may be provided in real-time to an advertiser. The current cost per click necessary to purchase advertising space from a particular advertising partner may, for example, be shown or displayed on an advertising device 102 (e.g., via display 500 and/or ticker 510). In some embodiments, the information may provided continuously and/or in real-time. The information may, for example, scroll across the advertiser's screen or display. In some embodiments, the information may be provided via any other practicable means that is or becomes known or available. For example, the information may be sent to an advertiser's pager, via e-mail, and/or through any other voice and/or data transmission means.

The method 600 may continue, according to some embodiments, at 606 by receiving an indication from the advertiser to modify an advertising parameter. In some embodiments, any other type of indication may also or alternatively be received. For example, an advertiser may click on a button (such as a button on the advertising ticker 510) to indicate that the advertiser would like to be contacted to discuss advertising management issues. In some embodiments, the advertiser may notice a particular parameter provided at 604 that may require updating or changing. The advertiser may notice, for example, that the advertiser's rank with a particular partner has dropped. In some embodiments, an alert or other indication or alarm may be provided to the advertiser to point out such a parameter change. The advertiser may wish to raise the cost per click bid with the partner to increase the rank.

At 608, the advertising parameter may be modified (e.g., in accordance with the advertiser's wishes). In some embodiments, the advertiser may click a button, for example, that dynamically (i.e., in real-time) alters any required and/or selected parameter. In some embodiments, the parameter may be altered based entirely or in part upon the indication received from the advertiser. The parameter may be adjusted and/or modified, for example, based on a pre-defined rule or set of rules established by the advertiser or by a UAM device, system, and/or entity. In some embodiments, the advertiser may indicate that a problem exists with a certain parameter and/or partner, and the UAM device or system may determine and/or take corrective measures to resolve any problems.

### ADDITIONAL EMBODIMENTS

The following illustrates various additional embodiments. These additional embodiments do not constitute a definition of all possible embodiments, and those skilled in the art will understand that many other embodiments may be possible and/or practicable. Further, although the following embodiments are briefly described for clarity, those skilled in the art will understand how to make any changes, if necessary, to the above-described apparatus and methods to accommodate these and other embodiments and applications.

According to some embodiments, an advertiser may register with a single entity and may accordingly be provided the opportunity to select various advertising partners of interest. The advertiser may then be automatically registered with any selected partners, allowing advertisements associated with the advertiser to be displayed by the selected partners. In some embodiments, the partners may be selected by the registering entity (e.g., a UAM entity).

According to some embodiments, the advertising ticker 510 may be provided in various forms on and/or through various devices. For example, scrolling advertising parameter information may be provided via a particular pager, phone, PDA, or other portable device. In some embodiments, the information and/or the presentation of the information may be customized by the advertiser. The information may also be sent in a compressed, encrypted, and/or other format or configuration.

The present invention has been described in terms of several embodiments solely for the purpose of illustration. Persons skilled in the art will recognize from this description that the invention is not limited to the embodiments described.

1. A method, comprising:
receiving registration information from an advertiser;
determining a plurality of advertising partners to be associated with the advertiser; and
automatically registering the advertiser with the plurality of advertising partners.

2. The method of claim 1, wherein the registration information comprises at least one of: an advertisement identifier, an advertisement, a desired value for an advertising parameter, or a desired range of values for an advertising parameter.

3. The method of claim 1, wherein the determining of the plurality of advertising partners is based at least in part on the registration information.

4. The method of claim 3, wherein the determining of the plurality of advertising partners comprises:
identifying a desired value for an advertising parameter associated with an advertisement of the advertiser;
identifying a plurality of advertising partners that are available to display the advertisement; and
determining that if the advertisement is displayed with at least one advertising partner from the plurality of advertising partners, that the desired value for the advertising parameter is likely to be satisfied.

5. The method of claim 4, wherein the desired value for the advertising parameter comprises a desired range of values for the advertising parameter.

6. The method of claim 1, wherein automatically registering the advertiser comprises:
providing at least one of the plurality of advertising partners with an advertisement of the advertiser.

7. The method of claim 1, wherein automatically registering the advertiser comprises:
providing at least one of the plurality of advertising partners with payment.

8. The method of claim 1, wherein the determining of the plurality of advertising partners comprises:
identifying an advertising partner criteria associated with the advertiser; and
determining at least one advertising partner from a plurality of advertising partners that meets the advertising partner criteria.

9. The method of claim 1, wherein the determining of the plurality of advertising partners and automatically registering the advertiser with the plurality of advertising partners is performed on a periodic basis.

10. A method, comprising:
determining an advertising parameter associated with an advertisement;
selecting an advertising partner to use to display the advertisement; and
causing the advertisement to be displayed by the advertising partner.

11. The method of claim 10, wherein the selecting of the advertising partner comprises:
identifying a plurality of advertising partners available to display the advertisement;
identifying an advertising metric associated with each of the plurality of advertising partners, wherein the advertising metric is associated with the advertising parameter; and
determining that one of the advertising metrics is compatible with the advertising parameter; and
selecting one of the advertising partners associated with the compatible advertising metric.

12. The method of claim 11, further comprising:
standardizing the advertising metrics associated with each of the plurality of advertising partners.

13. The method of claim 10, wherein causing the advertisement to be displayed by the advertising partner comprises:
providing the advertising partner with the advertisement.

14. The method of claim 10, wherein causing the advertisement to be displayed by the advertising partner comprises:
providing the advertising partner with payment.

15. The method of claim 10, wherein the determining of the advertising parameter associated with the advertisement is performed on a periodic basis.

16. The method of claim 10, wherein the determining of the advertising parameter associated with the advertisement is performed substantially continuously.

17. The method of claim 10, further comprising:
determining a value of the advertising parameter that is desirable to an advertiser associated with the advertisement; and
determining an advertising partner from a plurality of advertising partners that is associated with a value of the advertising metric that is closest to the desired value.

18. A method, comprising:
determining information associated with an advertisement;
providing the information to an advertiser in real-time;
receiving an indication from the advertiser; and
modifying an advertising parameter based at least in part on the indication received from the advertiser.

19. The method of 18, wherein the information includes the advertising parameter.

20. The method of claim 18, wherein the providing of the information to the advertiser in real time comprises:
updating the information on a substantially continuous basis; and
providing the updated information to the advertiser.

21. The method of claim 18, wherein the information is provided to the advertiser via an advertisement ticker displayed on a screen of a device associated with the advertiser.

22. The method of claim 21, wherein the receiving of the indication comprises:
determining that the advertiser has selected an item of the advertisement ticker.

23. The method of claim 18, wherein the modifying of the parameter comprises:
changing the value of the parameter; and
providing an indication of the changed value to an advertising partner that is displaying the advertisement.

24. An apparatus, comprising:
a processor; and
a storage device in communication with said processor and storing instructions adapted to be executed by said processor to:
receive registration information from an advertiser;
determine a plurality of advertising partners to be associated with the advertiser; and
automatically register the advertiser with the plurality of advertising partners.

25. An apparatus, comprising:
a processor; and
a storage device in communication with said processor and storing instructions adapted to be executed by said processor to:
determine an advertising parameter associated with an advertisement;
select an advertising partner to use to display the advertisement; and
cause the advertisement to be displayed by the advertising partner.

26. An apparatus, comprising:
a processor; and
a storage device in communication with said processor and storing instructions adapted to be executed by said processor to:
determine information associated with an advertisement;
provide the information to an advertiser in real-time;
receive an indication from the advertiser; and
modify an advertising parameter based at least in part on the indication received from the advertiser.

27. A medium storing instructions adapted to be executed by a processor to perform a method, said method comprising:
receiving registration information from an advertiser;
determining a plurality of advertising partners to be associated with the advertiser; and
automatically registering the advertiser with the plurality of advertising partners.

28. A medium storing instructions adapted to be executed by a processor to perform a method, said method comprising:
determining an advertising parameter associated with an advertisement;
selecting an advertising partner to use to display the advertisement; and
causing the advertisement to be displayed by the advertising partner.

29. A medium storing instructions adapted to be executed by a processor to perform a method, said method comprising:
determining information associated with an advertisement;
providing the information to an advertiser in real-time;
receiving an indication from the advertiser; and
modifying an advertising parameter based at least in part on the indication received from the advertiser.

30. An advertisement ticker, comprising:
a display object to display a value of an advertising parameter on a display screen, wherein the value of the advertising parameter is updated in real-time by receiving update information from a universal advertising server; and
an input object to receive an indication from an advertiser that the advertising parameter is to be changed and to provide the indication to the universal advertising server.

31. The advertisement ticker of claim 30, wherein the value of the advertising parameter displayed by the display object comprises a value of a first advertising parameter and wherein the advertising parameter to be changed comprises a second advertising parameter.

32. The advertisement ticker of claim 30, wherein the value of the advertising parameter is associated with a plurality of advertisements.
